(19) United States
(12) Patent Application Publication
(10) Pub. No.: US 2006/0196715 A1
(43) Pub. Date: Sep. 7, 2006

(54) Occupant protection device for vehicle

(75) Inventors: Teruhito Fujishiro, Hiroshima (JP); Hozumi Ozeki, Hiroshima (JP); Hideharu Kaeriyama, Hiroshima (JP); Ryoji Funahashi, Hiroshima (JP); Motoharu Hirata, Hiroshima (JP); Kenji Satani, Hiroshima (JP); Hiroshi Nakayama, Hiroshima (JP); Tamio Miyahara, Hiroshima (JP); Akihiro Kobayashi, Hiroshima (JP)

Correspondence Address: NIXON PEABODY, LLP, 401 9TH STREET, NW, SUITE 900, WASHINGTON, DC, 20004-2128, US

(73) Assignee: MAZDA MOTOR CORPORATION, Hiroshima (JP)

(21) Appl. No.: 11/358,215

(22) Filed: Feb. 22, 2006

(30) Foreign Application Priority Data
Mar. 7, 2005 (JP) 2005-062854
Mar. 4, 2005 (JP) 2005-061212
Mar. 4, 2005 (JP) 2005-061195

(51) Int. Cl. B60K 28/00; B60N 2/02; B60N 2/42

(52) U.S. Cl. 180/271; 180/268; 180/274; 280/730.2; 296/68.1; 297/216.1

(57) ABSTRACT

A seat cushion airbag unit is provided at each seat and includes a seat cushion airbag. The seat cushion airbag is disposed in an inboard portion of a seat cushion of the seat so as to support an inboard portion of buttocks of an occupant in the seat. The seat cushion airbag is changed from its inflated state from its shrunk state when the side crash or rollover of the vehicle is predicted by a controller. Thereby, the occupant's head is moved toward the center of the vehicle. Accordingly, the occupant protection device can promptly move the occupant's head toward the center of the vehicle, preventing the head from hitting against the vehicle roof, at the vehicle side crash or rollover.

### BACKGROUND OF THE INVENTION

The present invention relates to an occupant protection device for a vehicle.

Conventionally, the occupant protection device for a vehicle is known, in which an occupant (passenger) seated in a vehicle seat is prevented from hitting against a door or the like at a vehicle side crash or rollover.

For example, Japanese Patent Laid-Open Publication No. 2004-9798 discloses the occupant protection device for a vehicle in which the upper portion of occupant's body is moved away from the door at the vehicle side crash or rollover. This device comprises the moving device to move the occupant's head toward the center of the vehicle at the vehicle side crash or rollover. This moving device includes the airbag accommodated in the outboard (door-side) portion of the seat cushion and the movement portion operative to inflate the airbag at the vehicle side crash or rollover. Herein, the inflated airbag raises the outboard portion of the seat cushion. Thereby, the outboard portion of buttocks of the occupant is pushed up. Accordingly, the upper portion of the occupant's body leans toward the center of the vehicle and thereby the occupant's head is moved toward the center of the vehicle, so the upper portion of the occupant's body can be moved away from the door.

Likewise, Japanese Patent Laid-Open Publication No. 10-166918 discloses the occupant protection device for a vehicle in which the upper portion of the occupant's body can be moved away from the door at the vehicle side crash. Herein, the push frame is installed within the closed section of the cross member installed tight in the seat setting position of the floor panel in a state that its lateral side part is projected into the section of the side sill and the side end part is adjacently opposed to the inner side face of the side sill outer, and then the seat is attached to this push frame with bolts and the like. In time of the vehicle side crash, immediately after the side sill outer gets deforming inward, the push frame is forcibly pressed and its engagement with the cross member is released. Thereby, the seat is moved inward along with the push frame, so the upper portion of the occupant's body can be moved away from the door.

However, the devices disclosed by the above-described publications still have some problems to be improved.

Since the weight of occupant's body is relatively heavy and the body itself has flexibility to a certain degree, it may be difficult that the device disclosed in the former publication pushes up the outboard portion of the occupant's buttocks so quickly that the occupant's head could be moved toward the center of the vehicle promptly at the vehicle side crash or rollover. Also, the devise may require the relatively large-sized device. Furthermore, since the outboard portion of the occupant's buttocks is pushed up from its initial position, the occupant's head inevitably rises upward to a certain extent. Accordingly, there is a concern that the occupant's head would hit against the vehicle roof according to this control at the vehicle side crash or rollover.

Meanwhile, according to the device disclosed in the latter publication, the movement of the vehicle side crash is mechanically transferred to the seat, and thereby the upper portion of the occupant's body is moved away from the door. Accordingly, this device would also have a room to make improvements in promptness of the occupant's head movement toward the vehicle center.

### SUMMARY OF THE INVENTION

The present invention has been devised in view of the above-described problems, and an object of the present invention is to provide the occupant protection device for a vehicle that can promptly move the occupant's head toward the center of the vehicle, preventing the head from hitting against the vehicle roof, at the vehicle side crash or rollover.

According to the present invention, there is provided an occupant protection device for a vehicle, comprising a determining device operative to electrically predict or detect a vehicle side crash or rollover; and a moving device operative to move an occupant's head toward a center of the vehicle without a rise in a position of the occupant's head when the vehicle side crash or rollover is predicted or detected by the determining device.

Accordingly, since the occupant's head is moved toward the center of the vehicle without the rise in its position when the vehicle side crash or rollover is electrically predicted or detected, the movement of the occupant's head toward the center of the vehicle can be done promptly, and the head can be properly prevented from hitting against the vehicle roof.

According to an embodiment of the present invention, the moving device comprises a support portion operative to support an inboard portion of buttocks of the occupant, and a movement portion operative to deform, change or remove the support portion, thereby lowering the inboard portion of the occupants' buttocks when the vehicle side crash or rollover is predicted or detected by the determining device.

Accordingly, when the vehicle side crash or rollover is predicted or detected by the determining device, the support portion is deformed, changed or removed by the movement portion and thereby the inboard portion of the occupants' buttocks is lowered. Herein, the gravity (weights of the occupant and seat components) acting downward assists the inboard portion of the occupants' buttocks to be lowered, so this downward movement can be done in a relatively short time (promptly). Thus, the occupant's head can be moved promptly toward the center of the vehicle. Also, since the inboard portion of the occupants' buttocks is lowered, the occupant's head is moved downward. As a result, the head can be properly prevented from hitting against the vehicle roof.

According to another embodiment of the present invention, the support portion is accommodated in an inboard portion of a seat cushion of the seat, and the movement portion is configured so as to deform or change the support portion.

Accordingly, since the support portion may be designed so as to support substantially only the occupant because it is accommodated in the inboard portion of the seat cushion of the seat, the structure of the support portion can be made simple.

According to another embodiment of the present invention, the support portion is a seat mount that is located below an inboard portion of the seat, and the movement portion is configured so as to bend or remove the seat mount.

Accordingly, since the support portion is comprised of the seat mount and thereby the seat cushion needs not to be modified substantially, the comfortable sitting of the seat can be maintained properly.

According to another embodiment of the present invention, the occupant protection device further comprises a seatbelt device whose inboard end portion is fixed to an inboard end portion of the seat, wherein the seatbelt device comprises a seatbelt to restrain the occupant in the seat and a tension mechanism to apply a tension to the seatbelt according to a movement of the movement portion, thereby restraining a lower portion of an occupant's body in the seat cushion.

Accordingly, since the tension is applied to the seatbelt by the tension mechanism according to the movement and thereby the lower portion of the occupant's body is restrained in the seat cushion, the lower portion of the occupant's body is pulled downward. Thereby, by using the gravity and this downward pulling, the inboard portion of the occupants' buttocks can be lowered in a shorter time (more promptly). As a result, the occupant's head can be moved toward the center of the vehicle in the shorter time.

According to another embodiment of the present invention, the occupant protection device for a vehicle further comprises a seatbelt device whose inboard end portion is fixed to a central portion of a vehicle body, wherein the seatbelt device comprises the seatbelt to restrain the occupant in the seat and the tension mechanism to apply the tension to the seatbelt according to the movement of the movement portion, thereby restraining the lower portion of an occupant's body in the seat cushion.

Accordingly, the same function and effect as above can be attained.

According to another embodiment of the present invention, the tension mechanism is configured so as to apply the tension to the seatbelt according to the movement of the movement portion, thereby restraining the lower portion of the occupant's body in the seat cushion and an upper portion of the occupant's body in a seat back, a restraint timing of the lower portion of the occupant's body in the seat cushion being earlier than that of upper portion of the occupant's body in the seat back, or a restraint force of the lower portion of the occupant's body in the seat cushion being greater than that of the upper portion of the occupant's body in the seat back along with the same restraint timing.

Accordingly, since the restraint timing of the lower portion of the occupant's body in the seat cushion is configured so as to be earlier than that of upper portion of the occupant's body in the seat back, or the restraint force of the lower portion of the occupant's body in the seat cushion is configured to be greater than that of the upper portion of the occupant's body in the seat back along with the same restraint timing, the restraint of the upper portion of the occupant's body in the seat back is adjusted properly while the occupant's head is moved toward the center of the vehicle. Thereby, the movement of the occupant's head toward the center of the vehicle can be attained properly despite the restraint of the upper portion of the occupant's body in the seat back.

According to another embodiment of the present invention, the occupant protection device for a vehicle further comprises a pressing device that is provided at a side door, a pillar or a side wall portion of the vehicle and operative to push the occupant inward during or after an operation of the moving device.

Accordingly, since the occupant is pushed inward by the pressing device during or after the operation of the moving device, the movement of the occupant's head toward the center of the vehicle by the moving device is promoted. Thus, the occupant's head can be moved toward the center of the vehicle in the relatively short time.

According to another embodiment of the present invention, the pressing device is configured so as to push an outboard portion of an occupant's chest inward.

Accordingly, since the outboard portion of the occupant's chest that is relatively hard is pushed by the pressing device, the movement of the occupant's head toward the center of the vehicle by the moving device can be further promoted.

According to another embodiment of the present invention, the pressing device is configured so as to operate after the operation of the moving device.

Accordingly, since the pressing device operates (starts its operation) after the operation of the moving device (operation start), the occupant is not forced to take an uncomfortable position and thus the occupant can be pushed inward surely by the pressing device.

According to another embodiment of the present invention, the pressing device comprises a pressing airbag operative to be inflated inward after the vehicle side crash or rollover is predicted and when the vehicle side crash or rollover is detected by the determining device.

Accordingly, since the pressing device is configured of the airbag, the structure of the pressing device can be made simple.

Herein, since the airbag that has been inflated once may not return to its initial state without some particular operations, it is preferable that the inflation of the airbag is not carried out when the real vehicle side crash or rollover has been avoided.

According to the above-described embodiment, the pressing airbag is inflated inward after the vehicle side crash or rollover is predicted and when the vehicle side crash or rollover is detected by the determining device. Namely, when the vehicle side crash or rollover is not detected by the determining device, the pressing airbag is not inflated. Thus, the inflation of the pressing airbag is prevented when the vehicle side crash or rollover has been avoided.

According to another embodiment of the present invention, the occupant protection device for a vehicle further comprising a side airbag that is accommodated within the seat and operative to be inflated so as to cover an outboard portion of an upper portion of an occupant's body when the vehicle side crash or rollover is predicted or detected by the determining device, and the pressing device comprises a pressing airbag operative to be inflated inward and push the side airbag inward that is under inflation or inflated.

Generally, the side airbag is an airbag that is configured so as to be inflated widely.

According to the above-described embodiment, the pressing airbag pushes inward the side airbag that is under inflation or inflated. Thereby, the pressing airbag can properly use the relatively large side airbag, so the relatively large area can be pushed inward. Accordingly, the occupant can be pushed inward surely and properly regardless of the occupant's sitting position. As a result, the occupant's head can be moved surely toward the center of the vehicle.

According to another embodiment of the present invention, the occupant protection device for a vehicle further comprises a seat slide mechanism to enable the seat to slide in a vehicle longitudinal direction, and a drive device to operate the seat slide mechanism, wherein the seat is positioned by the seat slide mechanism when the vehicle side crash or rollover is predicted or detected by the determining device in such a manner that an outboard portion of the occupant is opposed to the pressing device.

Accordingly, since the seat is moved by the seat slide mechanism when the vehicle side crash or rollover is predicted or detected by the determining device such that the outboard portion of the occupant is opposed to the pressing device, the occupant can be surely moved inward by the pressing device despite of the seat's initial position. As a result, the occupant's head can be moved surely toward the center of the vehicle.

According to another embodiment of the present invention, the moving device is configured so as to lower an inboard portion of buttocks of the occupant when the vehicle side crash or rollover is predicted or detected by the determining device.

Accordingly, when the vehicle side crash or rollover is predicted or detected by the determining device, the inboard portion of buttocks of the occupant is lowered by the moving device. Herein, the outboard portion of the occupant's chest may not be changed in height during the operation of the moving device and after that operation. Thus, the outboard portion of the occupant's chest can be pushed surely by the pressing device.

According to another embodiment of the present invention, the vehicle includes a plurality of seats including a driver's seat, and the moving device is configured so as to move the occupant's heads seated in the plural seats toward the center of the vehicle by changing positions or forms of the plural seats in such a manner that a changing degree of the position or form of the driver's seat is smaller than that of a seat other than the driver's seat.

Accordingly, when the vehicle side crash or rollover is predicted or detected by the determining device, the occupant's heads seated in the plural seats are moved toward the center of the vehicle by changing positions or forms of the plural seats including the driver's seat. Herein, since the changing degree (extent) of the position or form of the driver's seat is smaller than that of the seat other than the driver's seat, the changing degree of the driver's position can be made relatively small. Thus, when the vehicle side crash is relatively small, the vehicle rollover is in the early stage, or the vehicle side crash or rollover is predicted, the driver can maneuver the vehicle properly to avoid the vehicle side crash or rollover.

Also, since the occupant's heads seated in the plural seats are moved toward the center of the vehicle by changing positions or forms of the plural seats including the driver's seat when the vehicle side crash or rollover is predicted or detected by the determining device as described above, the protection performance of the occupant protection device can be maintained on a high level.

Further, since the changing degree of the driver's position is made relatively small as described above, a dangerous situation can be avoided in which the driver would stop operations of a brake pedal or an accelerator and thereby the vehicle traveling would become unstable.

According to another embodiment of the present invention, the vehicle includes a plurality of seats including the driver's seat, and the moving device is configured so as to move the occupant's head seated in at least one of the plural seats that is other than the driver's seat toward the center of the vehicle by changing position or form of the at least one of the plural seats.

Accordingly, when the vehicle side crash or rollover is predicted or detected by the determining device, the head of the occupant seated in at least one of the plural seats that is other than the driver's seat is moved toward the center of the vehicle by changing position or form of the at least one of the plural seats. Namely, the position or form of the driver's seat is not changed when the vehicle side crash or rollover is predicted or detected by the determining device. Thus, the driver's position is not changed either. Accordingly, when the vehicle side crash is relatively small, the vehicle rollover is in the early stage, or the vehicle side crash or rollover is predicted, the driver can maneuver the vehicle properly to avoid the vehicle side crash or rollover.

Also, since the occupant's head seated in at least one of the plural seats that is other than the driver's seat is moved toward the center of the vehicle by changing position or form of the at least one of the plural seats when the vehicle side crash or rollover is predicted or detected by the determining device as described above, the protection performance of the occupant protection device can be maintained on the high level.

Further, since the driver's position is not changed, the dangerous situation can be avoided in which the driver would stop operations of the brake pedal or the accelerator and thereby the vehicle traveling would become unstable.

According to another embodiment of the present invention, the determining device is configured so as to predict or detect the vehicle rollover, and the moving device is configured so as to move an upper portion of body of the occupant toward the center of the vehicle when the vehicle rollover is predicted or detected by the determining device.

Herein, when the vehicle traveling is in an unstable state, such as a traveling situation where the vehicle is about to be rolled over receiving a relatively large lateral G acting on the vehicle laterally (including a situation where the vehicle travels with wheels located at either one side of the vehicle right and left sides that contact a ground surface), or where the vehicle is rolled over, the movement of the upper portion of the occupant's body toward the center of the vehicle would cause an inappropriate handling of the steering wheel by the driver, so that the vehicle traveling would become more unstable.

According to the above-described embodiment of the present invention, although the upper-portion bodies of the occupants seated in the plural seats are moved toward the center of the vehicle by changing positions or forms of the plural seats including the driver's seat when the vehicle side crash or rollover is predicted or detected by the determining device, the changing degree of the position or form of the driver's seat is smaller than that of the seat other than the driver's seat, or the position or form of the driver's seat is not changed. Thus, the movement of the upper portion of the driver's body toward the center of the vehicle is suppressed, so the vehicle traveling can be prevented from becoming more unstable.

According to another embodiment of the present invention, the moving device is configured so as to lower an inboard portion of buttocks of the occupant or raise an outboard portion of buttocks of the occupant when the vehicle rollover is predicted or detected by the determining device and the vehicle travels with wheels located at either one side of vehicle contacting a ground surface.

Herein, if the upper portion of the driver leans toward the center of the vehicle by lowering the inboard portion of driver's buttocks or raising the outboard portion of driver's buttocks when the vehicle travels with wheels located at either one side of vehicle contacting the ground surface, the steering wheel that the driver grips would be steered improperly toward the vehicle side of the wheels that do not contact on the ground surface. As a result, the vehicle rollover would be promoted.

According to the above-described embodiment of the present invention, although the inboard portion of driver's buttocks is lowered or the outboard portion of driver's buttocks is raised by changing positions or forms of the plural seats including the driver's seat when the vehicle side crash or rollover is predicted or detected by the determining device and the vehicle travels with wheels located at either one side of vehicle contacting the ground surface, the changing degree of the position or form of the driver's seat is smaller than that of the seat other than the driver's seat, or the position or form of the driver's seat is not changed. Thus, the leaning of the upper portion of the driver's body toward the center of the vehicle is suppressed, so the vehicle rollover can be prevented properly.

According to another embodiment of the present invention, the determining device is configured so as to predict or detect the vehicle rollover, the moving device is configured so as to move the upper portion of body of the occupant toward the center of the vehicle when the vehicle rollover is predicted or detected by the determining device, and the changing degree of the position or form of the driver's seat is configured so as to be smaller than that of the seat other than the driver's seat when the vehicle rollover is predicted and to be substantially the same as that of the seat other than the driver's seat after the vehicle rollover is predicted and when the vehicle rollover is detected by the determining device.

Accordingly, since the changing degree of the position or form of the driver's seat is configured so as to be smaller than that of the seat other than the driver's seat when the vehicle rollover is predicted and to be substantially the same as that of the seat other than the driver's seat after the vehicle rollover is predicted and when the vehicle rollover is detected by the determining device, the changing degree of the position or form of the driver's seat is kept smaller than that of the seat other than the driver's seat until the vehicle rollover is detected by the determining device. Thereby, the driver can conduct any necessary driving operations to avoid the vehicle rollover until it becomes certain that the vehicle rollover occurs. Herein, in changing the position or form of the plural seats when the vehicle rollover is predicted and then the vehicle rollover is detected, all seats may be changed in their positions or forms or only the driver's seat may be changed in its position or form.

Also, since the changing degree of the position or form of the driver's seat is configured so as to be substantially the same as that of the seat other than the driver's seat after the vehicle rollover is predicted and when the vehicle rollover is detected by the determining device, the driver can be protected surely when it is certain that the vehicle rollover occurs.

Other features, aspects, and advantages of the present invention will become apparent from the following description which refers to the accompanying drawings

### BRIEF DESCRIPTION OF THE DRAWINGS

FIG. 1 is a perspective view showing a normal state around an assistant's seat of a vehicle equipped with an occupant protection device for a vehicle according to an embodiment 1 of the present invention.

FIG. 2 is an elevation view showing the normal state around the assistant's seat.

FIG. 3 is a side view showing the normal state around the assistant's seat.

FIG. 4 is an elevation view of a first slide portion.

FIG. 5A is a schematic side view showing a normal state of the first slide portion, and FIG. 5B is a schematic side view showing a state of the first slide portion in which a vehicle side crash or rollover is predicted.

FIG. 6 is a side view showing a state around the assistant's seat in which the vehicle side crash or rollover is detected.

FIG. 7 is an elevation view showing a state around the assistant's seat in which the vehicle side crash or rollover is detected.

FIG. 8 is an elevation view showing a normal state around a driver's seat.

FIG. 9 is a side view showing the normal state around the driver's seat.

FIG. 10 is a schematic constitution diagram of the occupant protection device for a vehicle.

FIG. 11 is a flowchart showing a control by a controller of the occupant protection device for a vehicle.

FIG. 12 is a diagram showing a state of the vehicle traveling with wheels located at either one side of vehicle contacting a ground surface.

FIG. 13 is a perspective view showing a normal state around the assistant's seat of the vehicle equipped with the occupant protection device for a vehicle according to another embodiment 3 of the present invention.

FIG. 14 is a schematic elevation view of a seat cushion support member in a normal state and in a state in which the vehicle side crash or rollover is predicted.

FIG. 15 is an elevation view showing a normal state around the assistant's seat of the vehicle equipped with the occupant protection device for a vehicle according to another embodiment 4 of the present invention.

FIG. 16 is an elevation view showing the normal state of a seat mount.

FIG. 17 is an elevation view showing a state around the assistant's seat in which the vehicle side crash or rollover is detected.

FIG. 18 is an elevation view showing a state of the seat mount in which the vehicle side crash or rollover is predicted.

### DETAILED DESCRIPTION OF THE INVENTION

Hereinafter, preferred embodiments of the present invention will be described referring to the accompanying drawings.

### Embodiment 1

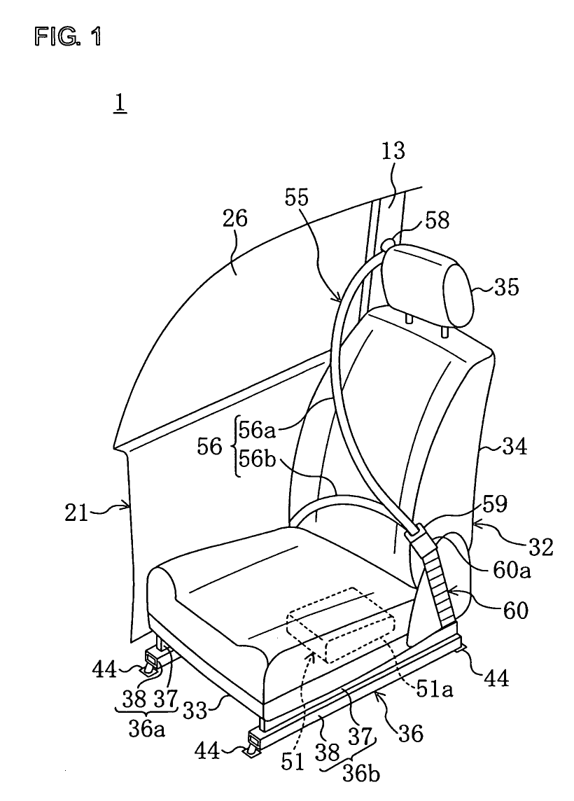

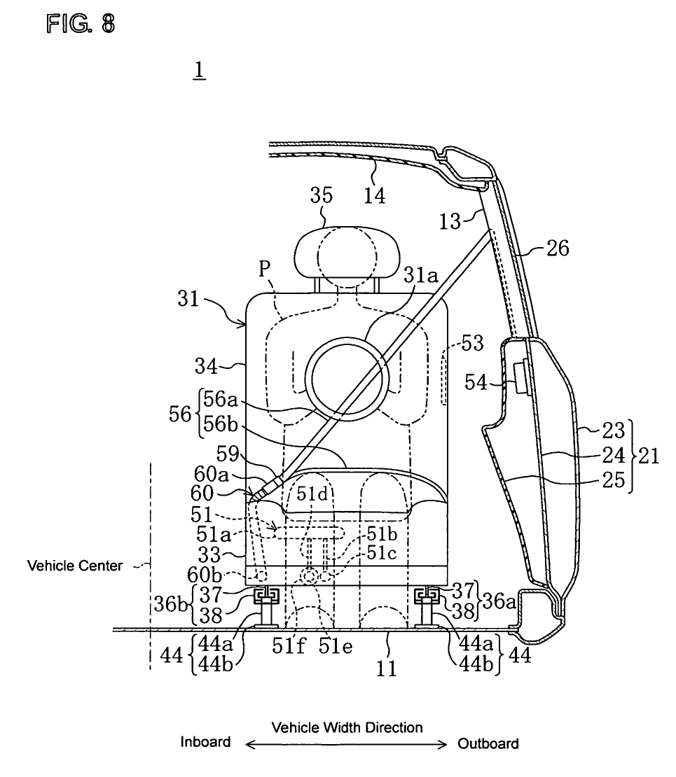

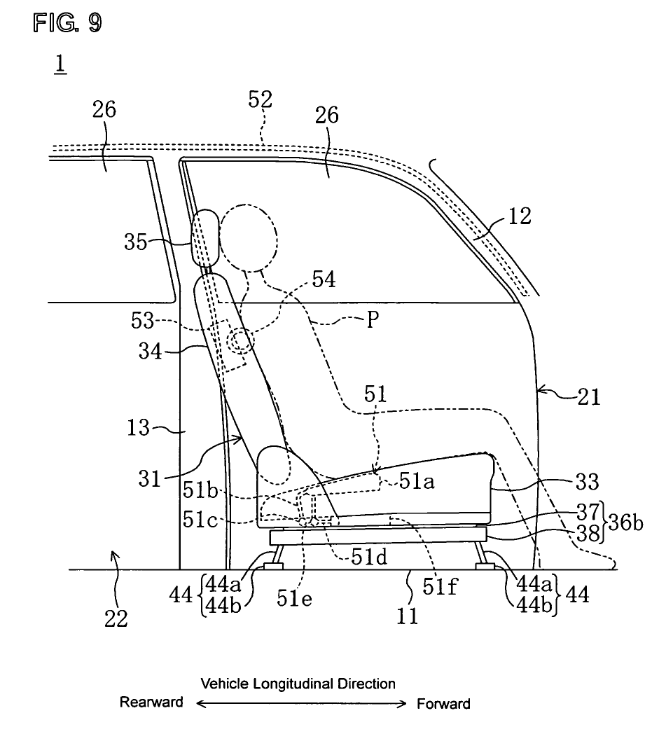

A vehicle 1 equipped with an occupant protection device for a vehicle 50 according to an embodiment 1 of the present invention comprises a vehicle body, side doors and seats. As shown in FIGS. 1 through 3, the vehicle body includes a floor panel 11, a pair of front pillars 12, a pair of center pillars 13, a pair of rear pillars (not illustrated), and a roof 14. The side doors include a pair of front doors 21 and a pair of rear doors 22. The doors 21, 22 include respectively outer panels 23, inner panels 24 located inside the outer panels 23, door trims 25 located inside the inner panels 24, and widow panes 26 covering window opening of the doors 21, 22. The seats include a front seat comprising a driver's seat 31 (see FIGS. 8 and 9) and an assistant's seat 32, which are disposed side by side on the floor panel 11, and a rear seat (not illustrated) disposed behind the front seat.

Hereinafter, the assistant's seat 32 will be described. Other seats, especially the driver's seat has substantially the same structure as the assistant's seat 32.

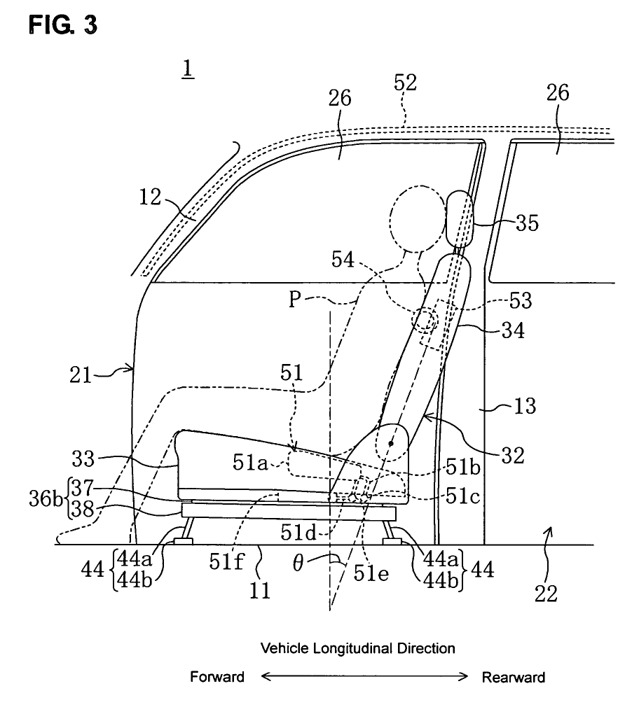

The assistant's seat 32 has a seat cushion 33, a seat back 34, and a headrest 35. The seat back 34 is attached to a rear end of the seat cushion 33 so as to change its standing angle relative to the upper face of the seat cushion 33. In the present embodiment, the rearward-inclined angle Θ of the seat back 34 in the normal state (for example, a driving state by the driver) relative to the vertical direction is set at 15 through 25 degrees (see FIG. 3). Herein, an angle changing mechanism 62, which will be described below, is not operated when the seat position is changed with the vehicle side crash or rollover. Namely, the rearward-inclined angle Θ is not changed when the seat position is changed. Thereby, an occupant P seated in the assistant's seat 32 may be prevented from feeling uncomfortable at the vehicle rear-slant crash. The headrest 35 is attached to an upper end of the seat back 34.

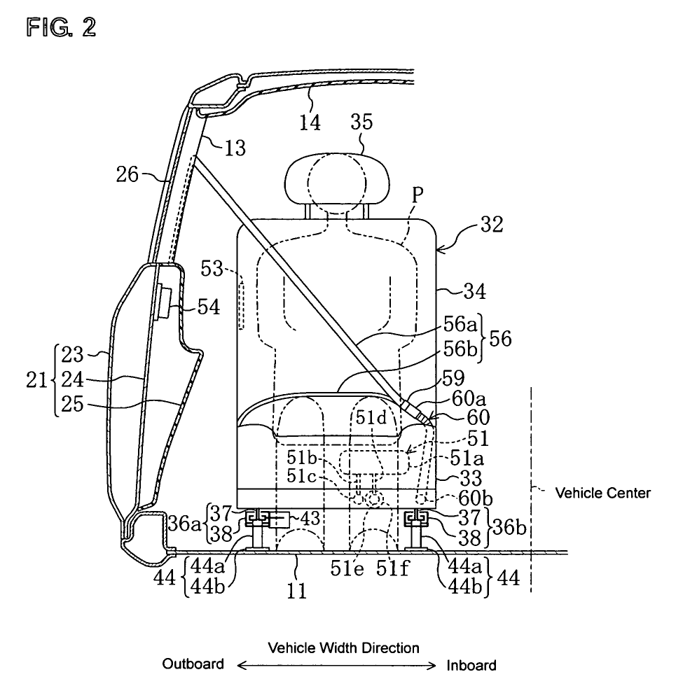

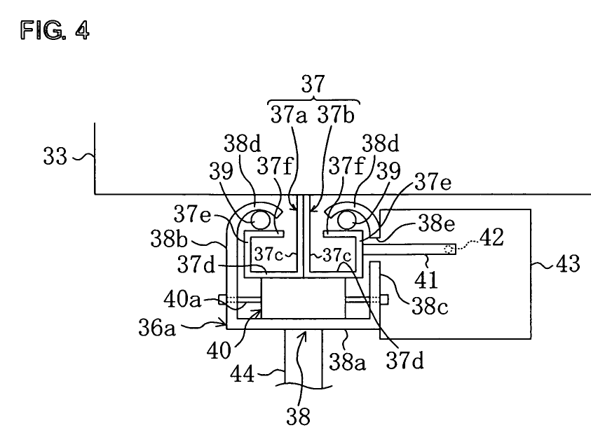

The assistant's seat 32 is equipped with a seat slide mechanism 36, the angle changing mechanism 62, and seat mounts 44. The seat slide mechanism 36, which can move the assistant's seat 32 in a longitudinal direction of the vehicle, comprises a first and second slide portions 36a, 36b that are disposed at both sides of a lower face of the seat cushion 33 of the assistant's seat 32. As illustrated in FIGS. 1 through 5, the first slide portion 36a is located at an outboard end of the lower face of the seat cushion 33 (at a side of the front door 21, on the left side in FIG. 2), and includes an upper slider portion 37, a lower guide portion 38, ball members 39, a roller 40, a parallel bar 41, and a link bar 42 (see FIG. 4). The second slide portion 36b is located at an inboard end of the lower face of the seat cushion 33 (on the right side in FIG. 2), and includes an upper slider portion 37, a lower guide portion 38, ball members 39, and a roller 40.

Hereinafter, the first slide portion 36a will be described. Herein, the second slide portion 36b has substantially the same structure as that of the first slide portion 36a except the parallel bar 41 and the link bar 42. The upper slider portion 37 is fixed to the lower face of the seat cushion 33, extending in the vehicle longitudinal direction, and engaged with the lower guide portion 38. The upper slider portion 37 is formed with a T-shaped cross section (see FIG. 4), and comprises a first and second plate members 37a, 37b that are placed side by side. The plate members 37a, 37b include first side wall portions 37c, lower wall portions 37d, second side wall portions 37e, and upper wall portion 37f. The first slide portion 37c is attached to the lower face of the seat cushion 33. The upper slider portion 37 can slide on the lower guide portion 38 in the vehicle longitudinal direction with the ball members 39 and the roller 40 as bearing.

The lower guide member 38 is fixed on the upper face of the floor panel 11 via the seat mount 44, extending in the vehicle longitudinal direction. The lower guide portion 38 is formed with a U-shaped cross section (see FIG. 4), and comprises a lower wall portion 38a, first and second side wall portions 38b, 38c, and a pair of upper wall portions 38d. The second side wall portion 38c has a slot 38e extending in the longitudinal direction. The both upper wall portions 38d are formed to project upward in a curved shape.

The ball portions 39 are located respectively between the upper wall portions 37f of the plate members 37a, 37b of the upper slider portion 37 and the upper wall portions 38d of the lower guide portion 38. The roller 40 is disposed between the lower wall portions 37d of the plate members 37a, 37b of the upper slider portion 37 and the lower wall portions 38a of the lower guide portion 38 in such a manner that a roller's central axis 40a extends in a vehicle width direction. Both ends of the central axis 40a of the roller 40 are fixed respectively to lower ends of the side wall portions 38b, 38c of the lower guide portion 38. Herein, the roller 40 disposed between the upper slider portion 37 and the lower guide 38 may need to be located at least at both ends in the vehicle longitudinal direction.

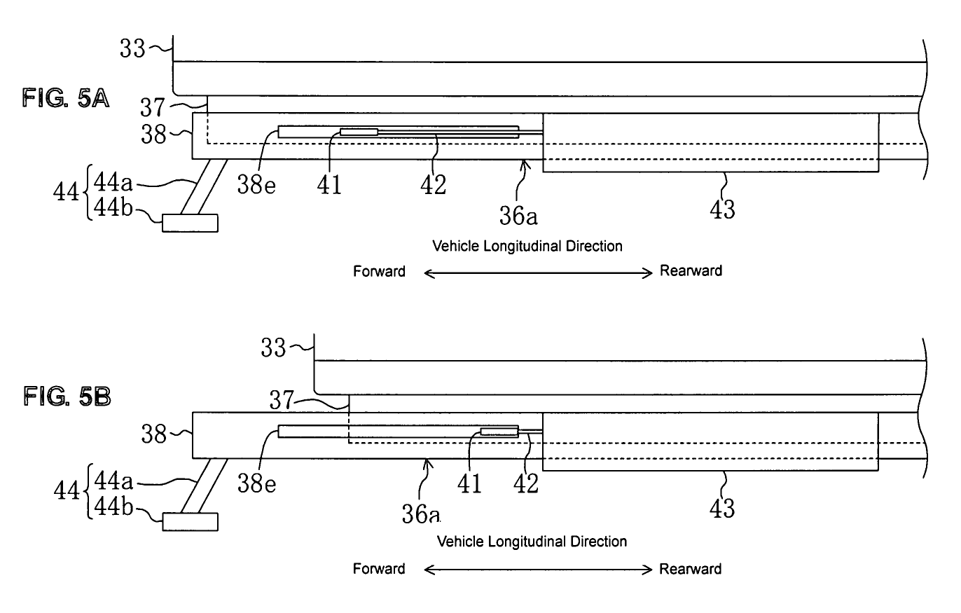

The parallel bar 41 is attached to an inboard face of the second side wall portion 37e of the second plate member 37b of the upper slider portion 37, going through the slot 38e of the lower guide portion 38, so as to extend in the vehicle width direction. The parallel bar 41 is located between the front end and the rear end of the slot 38e of the lower guide portion 38 in the normal state (see FIG. 5A), while it is located at the rear end of the slot 38e (see FIG. 5B) when the vehicle side crash or rollover is predicted by a controller 90 that will be described below. The link bar 42, which extends rearward from the parallel bar 41, is connected to a slide tensioner that will be described below.

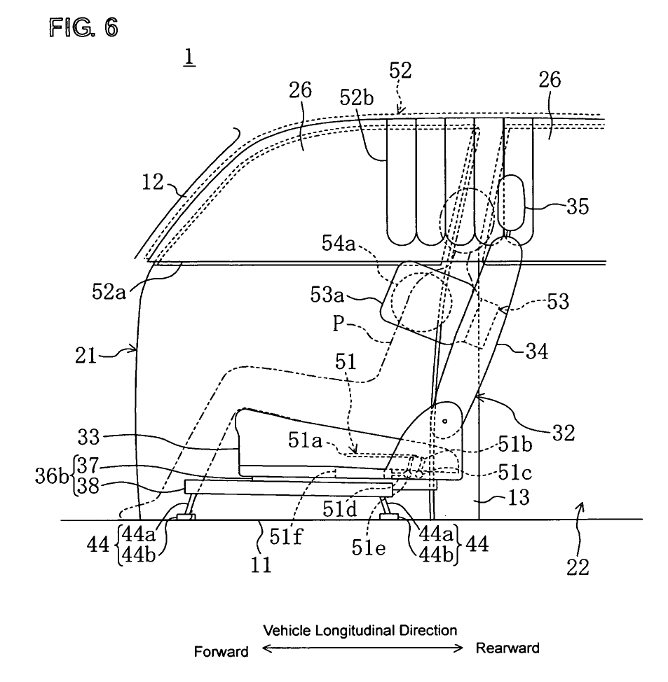

To an inboard face of the second side wall portion 38c of the lower guide portion 38 is attached the slide tensioner 43. The slide tensioner 43 is disposed in back of the slot 38e of the lower guide portion 38, and operates (drives) the seat slide mechanism 36 when the vehicle side crash or rollover is predicted by the controller 90. Thereby, the link bar 42 is pulled rearward (namely, the link bar 42 is withdrawn into the slide tensioner 43), and the parallel bar 41 contacts the rear end of the slot 38e of the lower guide portion 38 (see FIG. 5B). Accordingly, the upper slider portion 37 slides on the lower guide portion 38 in the longitudinal direction, so the assistant's seat 32 position is changed rearward as shown in FIG. 6. Specifically, the position of a front end of the headrest 35 is changed within a scope from the central position of the center pillar 13 to a 10-cm-rear position from the central position. Accordingly, the head of the occupant P seated in the assistant's seat 32 (namely, a portion right before the headrest 35 of the assistant's seat 32) is moved to a specified position near the center pillar 13. As a result, most part of the head of the occupant P is hidden by the center pillar 13 when viewed from the side. At the same time, the outboard portion of the upper portion of the occupant P (specifically, the occupant's chest) is located so as to be opposed to a pressing airbag 54a in the folded state (namely, a pressing airbag unit 54 in pre-operation state). Herein, at the first slide portion 36a of the driver's seat 31 is provided the parallel bar 41, the link bar 42 and the slide tensioner 43 (see FIG. 8). Namely, the position of the driver's seat 31 is not changed when the vehicle side crash and rollover is predicted by the controller 90. This is because if the position of the driver's seat 31 is changed, the driver may be prevented from maneuvering the vehicle properly. The first slide portion 36a has been described. Herein, the seat slide mechanism 36 may be operated manually by the occupant P, which will not described in detail here.

The above-described angle changing mechanism 62 changes the angle of the seat back 34 relative to the seat cushion 33, i.e., the rearward-inclined angle Θ of the seat back 34 relative to the vertical direction.

The above-described seat mounts 44 support to the assistant's seat 32 on the floor panel 11. The seat mounts 44 are provided at front and rear ends of the lower face of the lower wall portions 38a of the lower guide portions 38 of the both slide portions 36a, 36b, and comprise shaft members 44a and bottom plates 44b, respectively. The shaft members 44a are fixed to the bottom plates 44b, extending in the vertical direction. The bottom plates 44b are fixed to the floor panel 11. Herein, the seat mounts 44 of the second slide portion 36b are located below the inboard portion (specifically, an end portion) of the assistant's seat 32 so as to support the inboard portion of the assistant's seat 32 and an inboard portion (portion on the right in FIG. 2) of buttocks of the occupant P seated in the assistant's seat 32. The assistant's seat 32 is formed as described above.

Hereinafter, the occupant protection device for a vehicle 50 will be described referring to FIGS. 1 through 3 and 6 through 10. Although the description will be about the assistant's seat 32 mainly, other seats, especially the driver's seat 31, have substantially the same structure as that of the assistant's seat 32.

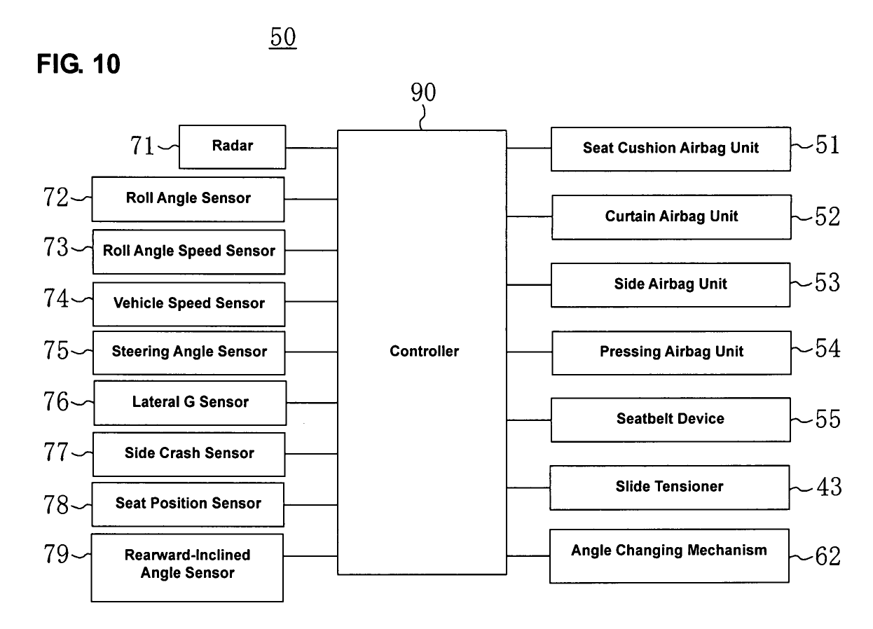

The occupant protection device for a vehicle 50 comprises, as illustrated in FIG. 10, a seat cushion airbag unit 51 (moving device), a curtain airbag unit 52, a side airbag unit 53, a pressing airbag unit 54, a three-point seatbelt device 55, the sliding tensioner 43, the angle changing mechanism 62, some sensors, and the controller 90 (determining device).

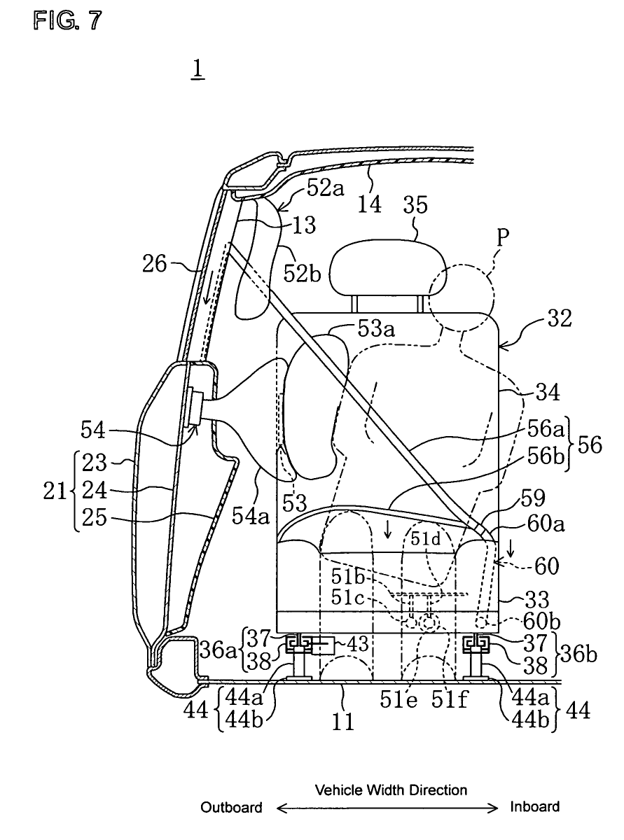

The seat cushion airbag unit 51 is provided at each seat as illustrated in FIGS. 1 through 3, 6 and 7. Namely, the seat cushion airbag unit 51 is provided above the upper slider portion 37 of the seat slide mechanism 36. The seat cushion airbag unit 51 includes a seat cushion airbag 51a, a gas releasing pipe 51b, a gas releasing valve 51c, a gas supply pipe 51d, a gas supply valve 51e, and a gas cylinder 51f. The seat cushion airbag 51a is accommodated in the rear portion of the seat cushion 33 to support the inboard portion (right-side portion in FIG. 2) of buttocks of the occupant P seated in the seat. Namely, the seat cushion airbag 51a is located below (right below) the inboard portion of the occupant's buttocks. The seat cushion airbag 51a is normally in an inflated state where it is filled with gas (see FIGS. 1 through 3). Accordingly, the upper face of the seat cushion airbag 51a keeps a flat face on the same levels of its both sides in the normal state. Meanwhile, when the vehicle side crash or rollover is predicted by the controller 90, the gas is exhausted from the seat cushion airbag 51a, so the seat cushion airbag 51a is changed to its shrunk state with its vertical length reducing (namely, the highest point of the airbag becomes lower than that in the inflated state) (see FIGS. 6 and 7). In this way, since the seat cushion airbag 51a is changed from its inflated state to its shrunk state when the vehicle side crash or rollover is predicted by the controller 90, the inboard portion of the rear part of the upper face of the seat cushion 33 is lowered by the weight of the occupant P. Thereby, the level of the inboard portion of the occupant's buttocks is lower than that of inboard portion (left-side portion in FIG. 7) of the occupant's buttocks. As a result, the upper portion of the occupant's body is leaned toward the center of the vehicle 1 (inward in FIG. 10, and thereby the upper portion of the occupant's body, i.e., the occupant's head is moved toward the center of the vehicle. At the same time, the head of the occupant is lowered because of the lean of the occupant's upper body.

The gas releasing pipe 51b is a pipe to release (exhaust) the gas in the seat cushion airbag bag 51. One end of the gas releasing pipe 51b opens inside the seat cushion airbag 51 and the other of that opens outside that. The gas releasing valve 51c is disposed in the gas releasing pipe 51b. The gas releasing valve 51c is normally in a closed state, and it is tuned to its open state when the vehicle side crash or rollover is predicted by the controller 90. Namely, when the vehicle side crash or rollover is predicted by the controller 90, the gas releasing valve 51c opens the gas releasing pipe 51b to release the gas in the seat cushion airbag 51a to the outside, and the seat cushion airbag 51a becomes from its open state to its shrunk state. Then, the gas releasing valve 51c closes again after a specified time (e.g., 5 seconds) has passed while no vehicle side crash or rollover is detected. Herein, the seat cushion airbag unit 51 is configured such that the seat cushion airbag 51a is changed from the closed state to the shrunk state within 3 seconds, preferably 1.6 seconds (a short specified time). In the present embodiment, the above-scribed time is set at 1 second.

The gas supply pipe 51d supplies the gas in the gas cylinder 51f into the seat cushion airbag 51. One end of the gas supply pipe 51d opens inside the seat cushion airbag 51 and the other of that is coupled to the gas cylinder 51f. The gas supply valve 51e is disposed in the gas supply pipe 51d. The gas supply valve 51e is normally in a closed state, and it is tuned to its open state when a specified time (e.g., 5 seconds) has passed while no vehicle side crash or rollover is detected by the controller 90 after the gas releasing valve 51c opens (namely, after the vehicle side crash or rollover is predicted by the controller 90). Then, after a specified time has passed, it returns to its closed state again. Thereby, the gas in the gas cylinder 51f is supplied to the seat cushion airbag 51a via the gas supply pipe 51d and the seat cushion airbag 51a is retuned from the shrunk state to the inflated state. The gas cylinder 51f is a container for the gas to be supplied to the seat cushion airbag 51a.

Herein, as illustrated in FIGS. 8 and 9, although the location of the seat cushion airbag 51a in the driver's seat 31 is almost similar to the one in the other seats, the vertical length of the driver's seat with the seat cushion airbag 51a in the inflated state (normal state) is shorter than that of the other seats with the seat cushion airbag 51a in the inflated state. Namely, the inflated volume of the seat cushion airbag 51a of the driver's seat 31 is smaller than that of the other seats. In other words, the seat cushion airbag 51a of the driver's seat 31 is smaller than that of the other seats. Thereby, when vehicle side crash or rollover is detected by the controller 90, the lowered change of the inboard portion of the upper face of the seat cushion 33 of the driver's seat 31 is smaller than that of the other seats. Namely, a changing degree of position or form of the driver's seat 31 is smaller (suppressed) than that of other seats when vehicle side crash or rollover is detected by the controller 90. Herein, the changing degree of the position or form of the seats means a degree of changing in position or form of the seats from the normal state. Accordingly, the lowered change of the inboard portion of the buttocks of the driver becomes smaller than that of the occupants seated in other seats. This means that the upper portion body of the driver does not lean toward the center of the vehicle not so much as that of the occupants in the seats other than the driver's seat. As a result, the movement of the driver's upper portion body, i.e., the diver's head toward the center of the vehicle becomes smaller that of the other occupants upper portion bodies, i.e., the other occupants heads.

The above-described curtain airbag unit 52 is provided along each front pillar 12 and side end of a roof 14, and comprises a curtain airbag 52a and an inflator (not illustrated) as illustrated in FIGS. 3, 6 and 7. The curtain airbag 52a is normally accommodated in the curtain airbag unit 52 in a folded state. When the vehicle side crash or rollover is detected by the controller 90, the curtain airbag 52a is inflated to cover inside faces of the window panes 26 of the front door 12 and rear door 22 (namely, the side window panes or upper portions of the doors 21, 22) (see FIGS. 6 and 7). The curtain airbag 52a located at the assistant seat 32 includes a plurality of inflation portions 52b (five portions in the present embodiment) that are inflated in substantially cylindrical shape to cover only upper part of the center pillar 13. Herein, the inflation portions 52b mean portions that have a thickness (a length in the vehicle width direction) of 5 cm or more in their inflated state. In the present embodiment, the inflation portions 52b are configured so as to have the thickness of 15 cm when they are inflated. Also, it is preferable that the inflation portions 52b are inflated so as to cover an area from a portion 40 cm before the front edge of the center pillar 13 to a portion 40 cm behind the front edge of the center pillar 13. In the present embodiment, they are configured so as to cover the area from the 40 cm before the front edge of the center pillar 13 to a 20 cm behind the front edge of the center pillar 13. Herein, since the occupant's head of the assistant's seat 32 is moved toward the center of the vehicle when the vehicle side crash or rollover is predicted by the controller 90 in the present embodiment, the upper portion body of the occupant P in the assistant's seat 32 moves away from the center pillar 13. Thereby, the inflation portions 52b can be configured to have the greater thickness in the inflation state. The curtain airbag 52a located at the driver's seat 31 also has the inflation portions 52b. Herein, as described above, the driver's seat 31 position is not changed when the vehicle side crash or rollover is predicted by the controller 90. Accordingly, it is preferable that the inflation portions 52b of the curtain airbag 52a at the driver's seat 31 is configured so as to cover a wider area than the inflation portions 52b of the curtain airbag 52a at the assistant's seat 32 in order to protect the driver properly. The above-described inflator operates to inflate the curtain airbag 52a according to the detection of the vehicle side crash or rollover by the controller 90.

The side airbag unit 53 is provided in an outside end portion of the seat back 34 of each seat, and comprises a side airbag 53a and an inflator (nor illustrated), as illustrated in FIGS. 2, 3, 6 and 7. The side airbag 53a is normally stored in the side airbag unit 53 in a folded state. When the vehicle side crash or rollover is detected by the controller 90, the side airbag 53a is inflated between the occupant P and the doors 21, 22 to cover an outboard portion (door-side portion) of the upper portion of the occupant's body (see FIGS. 6 and 7). The inflator operates to inflate the side airbag 53a according to the detection of the vehicle side crash or rollover by the controller 90.

As illustrated in FIGS. 2, 3, 6 and 7, the above-described pressing airbag unit 54 is provided at a rear portion (at a rear end portion of the front door 21 of the assistant's seat 32) of an inside face of each inner panel 24 of the doors 21, 22, which is located at substantially the same level as the chest of the occupant P. The pressing airbag unit 54 includes a pressing airbag 54a and an inflator (not illustrated). The pressing airbag 54a is normally stored in the pressing airbag unit 54 in a folded state. When the vehicle side crash or rollover is detected by the controller 90 (namely, at the same time when the side airbag 53a operates), the pressing airbag 54a is inflated inward to push inward the side airbag 53a that is under inflation or inflated (see FIGS. 6 and 7). Thereby, the chest of the occupant P is pushed inward via the side airbag 53a by the pressing airbag 54a when the vehicle side crash or rollover is detected by the controller 90. As a result, the movement of the occupant's head toward the center of the vehicle by the seat cushion airbag unit 51 is promoted. The inflator operates to inflate the pressing airbag 54a according to the detection of the vehicle side crash or rollover by the controller 90.

The above-described seatbelt device 55 comprises, as illustrated in FIGS. 1, 3 and 7, is provided at each seat, and comprises a seatbelt (webbing) 56, a retractor (not illustrated), a shoulder anchor 58, a tongue 59, and a buckle portion 60. The seatbelt 56 restrains the occupant P in the seat. The seatbelt 56 is wound up at its one end and attached to the outboard end of the seat cushion 33 in a sate where it goes through the shoulder anchor 58 and the tongue 59. The seatbelt 56 includes a shoulder belt portion 56a that is to restrain the upper portion of the occupant's body in the seat back 34 (downward) and a lap belt portion 56b that is to restrain the lower portion of the occupant's body in the seat cushion 33 (rearward).

The retractor is attached to a lower portion of the center pillar 13, and comprises a shoulder pre-tensioner that operates when the vehicle side crash or rollover is predicted by the controller 90 (with the open operation of the gas releasing valve 51c). Thus, the retractor winds up the shoulder seatbelt portion 56a to apply the tension to the seatbelt 56. As a result, the upper portion of the occupant's body is restraint in the seat back 34 by the shoulder belt portion 56a.

The shoulder anchor 58 is attached to an upper portion of the center pillar 13. The tongue 59 is operative to be inserted into a buckle hole 60a of the buckle portion 60. The tongue 59 engages with the buckle 60a, thereby restraining the occupant P in the seat with the seatbelt 56.

The buckle portion 60 is attached to the inboard end portion of the seat cushion 33. Namely, the outboard end of the seatbelt device 55 (the end located at the center side of the vehicle) is fixed to the inboard end portion of the seat. The buckle portion 60 includes a buckle 60a and a pre-tesnioner 60b. The buckle 60a is coupled to a lap pre-tensiner 60b. The lap pre-tensioner 60b operates when the vehicle side crash or rollover is predicted by the controller 90 (with the open operation of the gas releasing valve 51c) so as to pull down the buckle 60a (namely, the inboard end of the lap belt portion 56b). Thereby, the tension is applied to the seatbelt 56, thereby restraining the lower portion of the occupant's body in the seat cushion 33 by the lap belt portion 56b. Thus, since the buckle 60a is pulled downward when the vehicle side crash or rollover is predicted by the controller 90, the lower portion of the occupant's body is pulled down. As a result, the movement of the occupant's head toward the center of the vehicle by the shoulder airbag unit 51 is promoted.

The sensors comprise, as illustrated in FIG. 10, a radar 71, a roll angle sensor 72, a roll angle-speed sensor 73, a vehicle speed sensor 74, a steering angle sensor 75, a lateral G sensor 76, a side crash sensor 77, a seat position sensor 78, and a rearward-inclined angle sensor 79. The radar 71 detects a distance between the vehicle 1 and an object located near the vehicle. The roll angle sensor 72 detects a roll angle (rollover angle). The roll angle-speed sensor 73 detects a roll angle-speed. The vehicle speed sensor 74 detects a speed of the vehicle 1. The steering angle sensor 75 detects a steering angle of a steering wheel 31a (see FIG. 8). The lateral G sensor 76 detects an acceleration acting the vehicle in a lateral direction (the vehicle width direction). The side crash sensor 77, which is provided at a lower portion of the center pillar 13, detects an impact caused by the side crash of the vehicle 1. The seat position sensor 78 detects a position of each seat in the vehicle longitudinal direction. The rearward-inclined angle sensor 79 detects a rearward-inclined angle Θ of the seat back 34 of each seat relative to the vertical direction.

The controller 90 predicts or detects the side crash or rollover of the vehicle 1 based on the detection data from the sensors 71 through 79, and controls the seat cushion airbag unit 51 and the like as described above when that is predicted or detected. Herein, when the vehicle rollover is predicted by the controller 90, the vehicle may travel with wheels located at either one side of vehicle contacting the ground surface or travel with all wheels contacting the ground surface. Both situations of the vehicle traveling may be possible.

—Control of the Occupant Protection Device by the Controller—

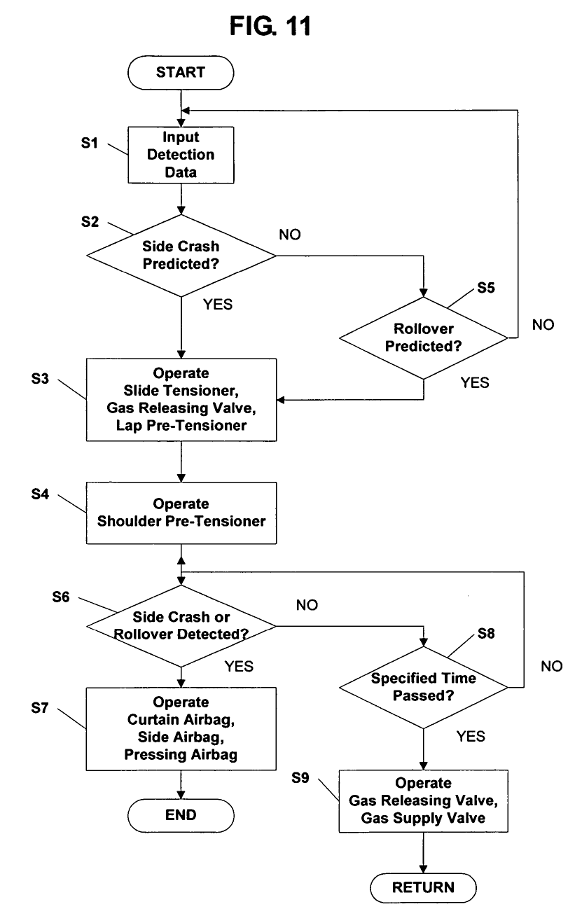

Hereinafter, the control of the occupant protection device by the controller 90 will be described referring to a flowchart shown in FIG. 11.

Detection data from the sensors 71-79 are inputted in step S1. In step S2, it is determined whether the side crash of the vehicle 1 is predicted or not based on the detection data from the sensors 71-79. Specifically, it is determined whether or not the vehicle will have the side crash in a while, i.e., 1 to 3 seconds, more preferably in 1 to 2 seconds. Herein, for example, the radar 71 or a camera detecting an obstacle object beside the vehicle detects the obstacle object existing beside the vehicle 1, the distance between the vehicle 1 and the obstacle object, a changing rate of this distance. And, when it is detected that the obstacle object exists beside the vehicle 1, the distance is closer than a specified distance, and an approaching speed, i.e., the changing rate of the distance, is more than a specified value, it is determined that the side crash of the vehicle has been predicted.

When the determination in the step S2 is YES, the control sequence proceeds to step S3, where the seat slide tensioner 43, the gas releasing valve 51c of the seat cushion airbag unit 51, and the lap pre-tensioner 60b of the seatbelt device 55 are operated at the same time.

Then, the slide tensioner 43 operates to change the seat position, so the occupant's head is moved to a specified position near the pillar 13 (see FIG. 6). Also, the gas releasing valve 51c operates to change the sate of the seat cushion airbag 51a from its inflated state to its shrunk state, so the occupant's head is moved toward the center of the vehicle 1 (see FIG. 7). Further, the lap pre-tensioner 60b operates to make the lap belt portion 56b restrain the lower portion of the occupant body in the seat cushion 33, so the movement of the occupant's head toward the center of the vehicle is promoted.

In step S4, the shoulder pre-tensioner of the seatbelt device 55 is operated. Thereby, the shoulder belt portion 56a retrains the upper portion of the occupant's body in the seat back 34. There exists a time lag between the step S3 and the step S4. Namely, the timing of the restraint of the lower portion of the occupant's body in the seat cushion 33 is set to be earlier than that of the upper portion of the occupant's body in the seat back 34.

When the determination in the step S2 is NO, the control sequence proceeds to step S5, where it is determined based on the detection data from the sensors 71-79 whether the vehicle rollover is predicted or not (namely, whether or not the vehicle is about to be rolled over). Specifically, when the roll angle is a first angle or more and the roll angle speed is a first speed or more, the vehicle speed is a specified speed or more and at least one of the steering angle and the changing rate of the steering angle is a specified value or more, the lateral G is a specified value or more, or the yaw rate of the vehicle 1 is specified or more, it is determined that the vehicle rollover has been predicted. Herein, it may be determined based on the vehicle speed, steering angle, and the changing rate of the steering angle that the vehicle rollover has been predicted due to the vehicle turning.

When the determination in the step S5 is YES, the control sequence proceeds to the step S3, while when the determination is NO, the control sequence returns to the step S1.

In step S6, it is determined based on the detection data from the sensors 71-79 whether the vehicle side crash or rollover is detected or not (namely, whether the side crash of the vehicle 1 is detected or not, or whether the rollover of the vehicle 1 is certain or not). Specifically, when a crash acceleration is a specified value or more (namely, the impact is a specified value or more), it is determined the vehicle side crash has been detected. Also, when the roll angle is a second angle or more and the roll angle speed is a second speed or more, it is determined that the vehicle rollover has been detected. Herein, the second angle and the second speed are greater than the first angle and the first speed, respectively. Also, when the vehicle rollover is predicted in the step S5 and just before the determination in the step S6 that the vehicle rollover is certain, the vehicle is under traveling with wheels located at either one side of vehicle contacting the ground surface, and the movement of the occupant's head toward the center of the vehicle is done (see the step S3).

When the determination in the step S6 is YES, the control sequence proceeds to step S7, where the inflators of the curtain airbag unit 52, the side airbag unit 53 and pressing airbag unit 54 are operated at the same time. Namely, after the operation of the seat cushion airbag unit 51 (after the shrinkage operation starts), the curtain airbag 52a, side airbag 53a and pressing airbag 54a are operated (inflation start) to be inflated at the same time. Thereby, the pressing airbag 54a pushes the outboard portion of the occupant's chest inward via the side airbag 53a, so the movement of the occupant's head toward the center of the vehicle is promoted (see FIG. 7). Herein, gas volume to inflate the pressing airbag 54a corresponding to the driver's seat 31 (the driver P) is smaller than that of the pressing airbags 54a corresponding to the other seats (occupants P seated in the other seats). Or, a vent hole of the pressing airbag 54a corresponding to the driver's seat 31 is greater than that the pressing airbags 54a corresponding to the other seats. Then, the control sequence proceeds to the end.

When the determination in the step S6 is NO, the control sequence proceeds to step S8, where it is determined whether or not a specified time of period has passed without detecting the vehicle side crash or rollover (namely, whether or not the vehicle crash or rollover has been avoided).

When the determination in the step S8 is YES, the control sequence proceeds to step S9, where the gas releasing valve 51c and the gas supply valve 51e of the seat cushion airbag unit 51 are operated at the same time. Thereby, the seat cushion airbag 51a is returned from the shrunk state to the inflated state, so the occupant P is returned to the initial position. Then the control sequence returns to the start. Meanwhile, when the determination in the step S8 is NO, the control sequence returns to the step S6.

Accordingly, according to the present embodiment, when the vehicle side crash or rollover is predicted or detected by the controller 90, the seat cushion airbag 52a is deformed and thereby the inboard portion of the occupants' buttocks is lowered. Herein, the gravity (weights of the occupant and seat components) acting downward assists the inboard portion of the occupants' buttocks to be lowered, so this downward movement can be done in the relatively short time (promptly). Thus, the occupant's head can be moved promptly toward the center of the vehicle.

Also, since the inboard portion of the occupants' buttocks is lowered, the occupant's head is moved downward. As a result, the head of the occupant P can be properly prevented from hitting against the roof 14.

Also, since the support portion (the seat cushion airbag 51a of the present embodiment) is accommodated in the inboard portion of the seat cushion 33, the support portion can be designed so as to support substantially only the occupant P. As a result, the structure of the support portion can be made simple.

Also, since the tension is applied to the seatbelt 56 by the lap pre-tensioner 60b with the opening operation of the gas releasing valve 51c and thereby the lower portion of the occupant's body is restrained in the seat cushion 33 by the seat belt 56, the lower portion of the occupant's body is pulled downward. Thereby, by using the gravity and this downward pulling, the inboard portion of the occupants' buttocks can be lowered in the short time (more promptly). As a result, the occupant's head can be moved toward the center of the vehicle in the short time.

Herein, although the buckle portion 60 is attached to the inboard end of the seat cushion 33 of the seat in the present embodiment, it may be attached to the center of the upper face of the floor panel 11.

Accordingly, according to the present embodiment, since the occupant P is pushed inward by the pressing airbag 54a during or after the shrinkage operation of the seat cushion airbag unit 51, the movement of the occupant's head toward the center of the vehicle by the seat cushion airbag unit 51 is promoted. Thus, the occupant's head can be moved toward the center of the vehicle in the relatively short time. Thus, the head of the occupant P can be prevented from hitting against the window pane 26 of the door 21, the trim of the pillar 13 or the curtain airbag 52a.

Also, since the outboard portion of the occupant's chest that is relatively hard is pushed by the pressing airbag 54a, the movement of the occupant's head toward the center of the vehicle by the moving seat cushion airbag unit 51 can be further promoted.

Also, since the pressing airbag 54a operates (starts its operation) after the operation of the moving seat cushion airbag unit 51 (operation start), the occupant P is not forced to take the uncomfortable position and thus the occupant P can be pushed inward surely by the pressing airbag 54a.

Also, since the pressing device is configured of the airbag 54a, the structure of the pressing device can be made simple.

Herein, since the airbag that has been inflated once may not return to its initial state without some particular operations, it is preferable that the inflation of the airbag is not carried out when the real vehicle side crash or rollover has been avoided.

According to the above-described embodiment, the pressing airbag 54a is inflated inward after the vehicle side crash or rollover is predicted and when the vehicle side crash or rollover is detected by the controller 90. Namely, when the vehicle side crash or rollover is not detected by the controller 90, the pressing airbag 54a is not inflated. Thus, the inflation of the pressing airbag 54a is prevented when the vehicle side crash or rollover has been avoided.

Generally, the side airbag 53a is an airbag that is configured so as to be inflated widely.

According to the above-described embodiment, the pressing airbag 54a pushes inward the side airbag 53a that is under inflation or inflated. Thereby, the pressing airbag 54a can properly use the relatively large side airbag 53a, so the relatively large area can be pushed inward. Accordingly, the occupant P can be pushed inward surely and properly regardless of the occupant's sitting position. As a result, the occupant's head can be moved surely toward the center of the vehicle.

Also, since the pressing airbag 54a pushes the outboard portion of the occupant P inward via the relatively large side airbag 53a that is under inflation or inflated, the longitudinal-direction length and the vertical-direction length of the pressing airbag 54a in the inflated state can be short.

Also, since the seat is moved by the seat slide mechanism 36 when the vehicle side crash or rollover is predicted or detected by the controller 90 such that the outboard portion of the occupant P is opposed to the pressing airbag 54a, the occupant P can be surely moved inward by the pressing device regardless of the seat's initial position. As a result, the occupant's head can be moved surely toward the center of the vehicle.

Also, when the vehicle side crash or rollover is predicted or detected by the controller 90, the inboard portion of buttocks of the occupant is lowered by the seat cushion airbag unit 51. Herein, the outboard portion of the occupant's chest may not be changed in height during the shrinkage operation of the seat cushion airbag unit 51 and after that operation. Thus, the outboard portion of the occupant's chest can be pushed surely by the pressing device.

According to the above-described embodiment, when the vehicle side crash or rollover is predicted by the controller 90, the occupant's heads seated in the plural seats are moved toward the center of the vehicle by changing positions or forms of the plural seats including the driver's seat 31 by the seat cushion airbag unit 51. Herein, since the changing degree of the position or form of the driver's seat 31 is smaller than that of the seat other than the driver's seat 31, the changing degree of the driver's position can be made relatively small. Thus, when the vehicle side crash is relatively small, the vehicle rollover is in the early stage, or the vehicle side crash or rollover is predicted, the driver can maneuver the vehicle properly to avoid the vehicle side crash or rollover.

Also, since the occupant's heads seated in the plural seats are moved toward the center of the vehicle by changing positions or forms of the plural seats including the driver's seat when the vehicle side crash or rollover is predicted as described above, the protection performance of the occupant protection device 50 can be maintained on the high level.

Further, since the changing degree of the driver's position is made relatively small as described above, a dangerous situation can be avoided in which the driver P would stop operations of a brake pedal or an accelerator and thereby the vehicle traveling would become unstable.

Herein, when the vehicle traveling is in an unstable state, such as a traveling situation where the vehicle 1 is about to be rolled over receiving a relatively large lateral G acting on the vehicle 1 laterally, or where the vehicle 1 is rolled over, the movement of the upper portion of the occupant's body toward the center of the vehicle would cause an inappropriate handling of the steering wheel 31a by the driver P, so that the vehicle traveling would become more unstable.

According to the above-described embodiment of the present invention, although the upper-portion bodies of the occupants seated in the plural seats are moved toward the center of the vehicle by changing positions or forms of the plural seats including the driver's seat 31 by the seat cushion airbag unit 51 when the vehicle side crash or rollover is predicted by the controller 90, the changing degree of the position or form of the driver's seat 31 is smaller than that of the seat other than the driver's seat 31, or the position or form of the driver's seat is not changed. Thus, the movement of the upper portion of the driver's body toward the center of the vehicle 1 is suppressed, so the vehicle traveling can be prevented from becoming more unstable.

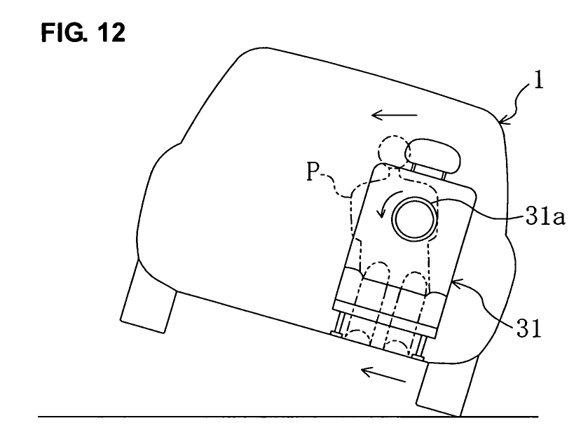

Herein, if the upper portion of the driver P leans toward the center of the vehicle by lowering the inboard portion of driver's buttocks or raising the outboard portion of driver's buttocks when the vehicle travels with wheels located at either one side of vehicle contacting the ground surface as illustrated in FIG. 12, the steering wheel 31a that the driver P grips would be steered improperly toward the vehicle side of the wheels that do not contact on the ground surface. As a result, the vehicle rollover would be promoted.

According to the above-described embodiment of the present invention, although the inboard portion of driver's buttocks is lowered or the outboard portion of driver's buttocks is raised by changing positions or forms of the plural seats including the driver's seat 31 by the seat cushion airbag unit 51 when the vehicle side crash or rollover is predicted by the controller 90 and the vehicle 1 travels with wheels located at either one side of vehicle contacting the ground surface, the changing degree of the position or form of the driver's seat 31 is smaller than that of the seat other than the driver's seat, or the position or form of the driver's seat is not changed. Thus, the leaning of the upper portion of the driver's body toward the center of the vehicle is suppressed, so the vehicle rollover can be prevented properly.

Herein, although the changing degree of the position or form of the driver's seat 31 is set be smaller than that of the seat other than the driver's seat 31 in the present embodiment, the following setting may also be applicable. Namely, when the vehicle rollover is predicted (including a situation where the vehicle 1 travels with wheels located at either one side of the vehicle contacting the ground surface) or detected by the controller 90, the position or form of the seats including the driver's seat 31 is changed. And, the changing degree of the position or form of the driver's seat 31 is configured so as to be smaller than that of the seat other than the driver's seat when the vehicle rollover is predicted by the controller 90 and to be substantially the same as that of the seat other than the driver's seat after the vehicle rollover is predicted and when the vehicle rollover is detected by the controller 90. In other words, when vehicle rollover is predicted by the controller 90, the lowered change of the inboard portion of the upper face of the seat cushion 33 of the driver's seat 31 is smaller than that of the other seats. While, when the vehicle rollover is detected by the controller 90, the lowered change of the inboard portion of the upper face of the seat cushion 33 of the driver's seat 31 is substantially the same as that of the other seats. Herein, the changing degree of the position or form of the other seats when the vehicle rollover is detected by the controller 90, is greater than or the same as that thereof when the vehicle rollover is predicted by the controller 90. Accordingly, until the vehicle rollover is detected by the controller 90, the changing degree of the position or form of the driver's seat 31 is smaller (suppressed) than that of the seat other than the driver's seat 31. Thereby, the driver can conduct any necessary driving operations to avoid the vehicle rollover until it becomes certain that the vehicle rollover occurs. Also, since the changing degree of the position or form of the driver's seat 31 is substantially the same as that of the seat other than the driver's seat after the vehicle rollover is predicted and when the vehicle rollover is detected by the controller 90, the driver can be protected surely after it becomes certain that the vehicle rollover occurs. Herein, in changing the positions or forms of the plural seats when the vehicle rollover is predicted and then the vehicle rollover is detected, all seats may be changed in their positions or forms or only the driver's seat may be changed in its position or form. Specifically, for example, the vertical length of the inflated seat cushion airbag 51a of the driver's seat 31 is set to be the same as that of the inflated seat cushion airbag 51a of the other seats (namely, the same size airbags 51a are adopted), and when the vehicle rollover is predicted and detected by the controller 90, the gas is released from each seat cushion airbag 51a by adjusting the releasing volume properly.

Also, although the above-described embodiment adopts the seat cushion airbag unit 51 as the moving device, any other devices may be used in order to move the occupant's head toward the center of the vehicle 1 when the vehicle side crash or rollover is predicted by the controller 90. For example, a device for leaning the seat, or a device for making the seat slide may be adopted. Also, another modification may be used as a device to lower the inboard portion of the occupant's buttocks (for example, the support member that is accommodated in the inboard portion of the seat cushion 33 and can change its height, or the seat mount 44 that is located below the inboard portion of the seat cushion 33 and can bend).

Also, although the above-described embodiment uses the seat cushion airbag 51a of the driver's seat 31 that has the smaller volume than the seat cushion airbag 51a of the other seats, another modification instead may be applied where the gas releasing valve 51a and the lap pre-tensioner 60b of the driver's seat 31 have different properties from those of the other seats, namely, the operational speed, operational amount, or operational time of the gas releasing valve 51a and the lap pre-tensioner 60b of the driver's seat 31 are set to be smaller than those of the gas releasing valve 51a and the lap pre-tensioner 60b of the other seats. Thereby, the similar function and effects can be obtained.

Also, although the above-described embodiment adopts the changing degree of the position or form of the driver's seat 31 being smaller than that of the other seats when the vehicle rollover is predicted by the controller 90, the front seat comprised of the driver's seat 31 and the assistant's seat 32 may be applied, whose changing degree of the position or form is smaller that of the rear seat (for example, a second-row seat or a third-row seat).

Herein, the leaning of the upper portion of the occupant's body toward the vehicle center is not suppressed by the seatbelt device 55 and the like. Therefore, in the case where the changing degree of the position or form of the driver's seat 31 is smaller than that of the other seats including the assistant's seat 32 when the vehicle rollover is predicted by the controller 90, the upper portion body of the occupant P seated in the assistant's seat 32 is inclined greatly toward the driver P when the vehicle rollover is predicted, so there is a concern that the occupant P in the assistant's seat 32 and the driver P would contact each other. Accordingly, the above-described setting of the changing degree of the position or form of the front seat that is smaller than that of the rear seat may avoid the contact between the driver P and the occupant P in the assistant' seat. Thus, the driver P can maneuver the vehicle properly to avoid the vehicle side crash or rollover.

### Embodiment 2

In the present embodiment 2, the driver's seat 31 does not comprise the above-described seat cushion airbag unit 51, pressing airbag unit 54, parallel bar 41, link bar 42 and slide tensioner 43. Therefore, only the driver's seat 31 does not change its position or form when the vehicle side crash or rollover is predicted by the controller 90. Accordingly, when the vehicle side crash or rollover is predicted by the controller 90, the upper portion body, or the head of the driver P is not moved toward the center of the vehicle 1.

According to the present embodiment, when the vehicle side crash or rollover is predicted by the controller 90, the occupant's heads seated in the seats other than the driver's seat are moved toward the center of the vehicle by changing position or form of those seats. Namely, when the vehicle side crash or rollover is predicted by the controller 90, the driver's seat position or form is not changed. Thus, the driver's position is not changed. Accordingly, when the vehicle side crash is relatively small, the vehicle rollover is in the early stage, or the vehicle side crash or rollover is predicted, the driver P can maneuver the vehicle properly to avoid the vehicle side crash or rollover.

Meanwhile, since the occupant's head seated in at least one of the plural seats that is other than the driver's seat 31 is moved toward the center of the vehicle by changing position or form of the at least one of the plural seats when the vehicle side crash or rollover is predicted as described above, the protection performance of the occupant protection device 50 can be maintained on the high level.

Further, since the driver's position is not changed, the dangerous situation can be avoided in which the driver would stop operations of the brake pedal or the accelerator and thereby the vehicle traveling would become unstable.

Herein, when the vehicle traveling is in an unstable state, such as a traveling situation where the vehicle 1 is about to be rolled over receiving a relatively large lateral G acting on the vehicle 1 laterally, or where the vehicle 1 is rolled over, the movement of the upper portion of the occupant's body toward the center of the vehicle would cause an inappropriate handling of the steering wheel 31a by the driver P, so that the vehicle traveling would become more unstable.

According to the present embodiment, the position or form of the driver's seat 31 is not changed when the vehicle side crash or rollover is predicted by the controller 90. Thus, the movement of the upper portion of the driver's body toward the center of the vehicle 1 is suppressed, so the vehicle traveling can be prevented from becoming more unstable.

Herein, if the upper portion of the driver P leans toward the center of the vehicle by lowering the inboard portion of driver's buttocks or raising the outboard portion of driver's buttocks when the vehicle travels with wheels located at either one side of vehicle contacting the ground surface as illustrated in FIG. 12, the steering wheel 31a that the driver P grips would be steered improperly toward the vehicle side of the wheels that do not contact on the ground surface. As a result, the vehicle rollover would be promoted.

According to the present embodiment, the position or form of the driver's seat 31 is not changed when the vehicle side crash or rollover is predicted by the controller 90 and the vehicle 1 travels with the either side of the vehicle contacting the ground surface. Thus, the movement of the upper portion of the driver's body toward the center of the vehicle 1 is suppressed, so the vehicle traveling can be prevented from becoming more unstable.

Herein, only the driver's seat 31 has no seat cushion airbag unit 51 in the present embodiment. Namely, although all other seats than the driver's seat 31 have the seat cushion airbag unit 51, this unit 51 may be provided at least one of the seats other than the driver's seat 31.

### Embodiment 3

The present embodiment 3 includes a seat cushion support member 65 as the support portion and a hydraulic driving device 66 as the movement portion. Although hereinafter the present embodiment that is applied to the assistant seat will be described, this embodiment can be applied to the driver's seat as well.

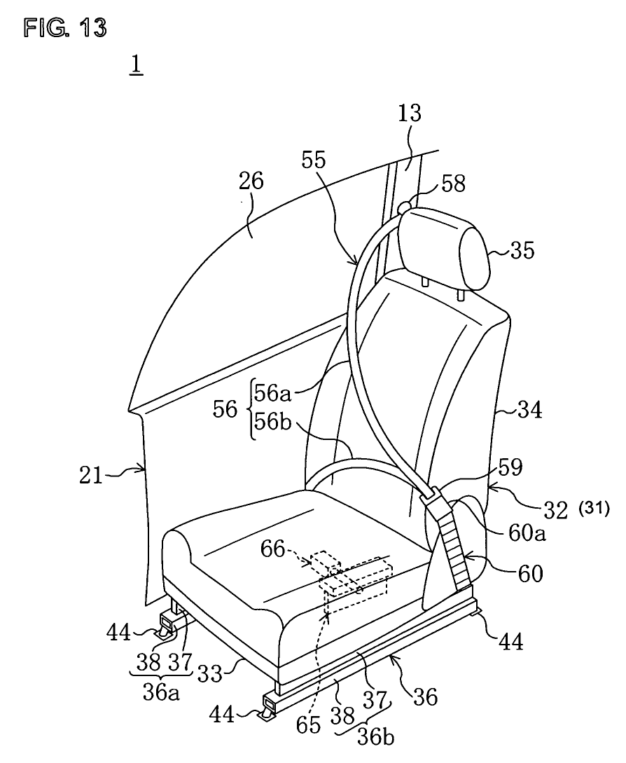

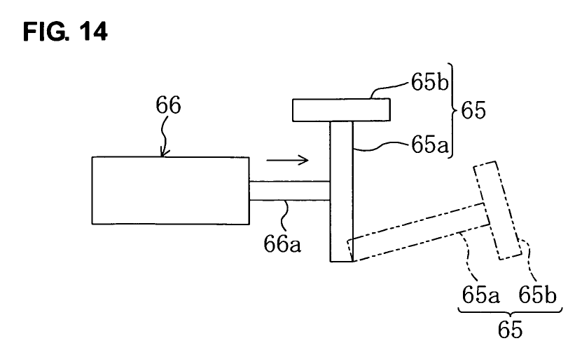

As illustrated in FIGS. 13, 14, the seat cushion 33 is accommodated within a space at the inboard portion of the rear part of the seat cushion 33, extending longitudinally and supporting the inboard portion of buttocks of the occupant P seated in the seat. The seat cushion support member 65 is formed with a T-cross section and includes a vertical wall portion 65a and a lateral wall portion 65b. This support member 65 is rotatable around an axis that extends longitudinally and is located at the lower end of the vertical wall portion 65a. The lateral wall portion 65b is attached to the upper end of the vertical wall portion 65a so as to extend in the vehicle width direction and is located below (right below, specifically) the inboard portion of the occupant's buttocks. The support member 65 has its normal position with the vertical wall portion 65a that extends in the vertical direction (see the support member 65 shown by solid lines in FIG. 14). Meanwhile, when the vehicle side crash or rollover is predicted by the controller 90, the support member 65 falls down inward (toward the vehicle center) with its uppermost position being lower than that in its standing state (see the support member 65 shown by two-dotted broken lines in FIG. 14). Thus, since the support member 65 changes from its standing state to its fall state (namely, it is lowered) when the vehicle side crash or rollover is predicted by the controller 90, the inboard portion of the rear part of the seat cushion 33 is lowered by the weight of the occupant P. As a result, the upper portion body of the occupant P is inclined toward the vehicle center, the upper portion body, or the head of the occupant P is moved toward the vehicle center. Thus, the support member 65 is inclined inward, or in a direction away from the occupant P, the occupant P can be prevented from feeling uncomfortable.

The driving device 66 includes a rod 66a and is located outboard the support member 65 in the seat cushion 33. The rod 66a extends and pushes the vertical wall portion 65a inward according to the prediction of the vehicle side crash or rollover by the controller 90, so the support member 65 rotates around the axis. Thereby, the support member changes from its standing state from its fall state in the short time of 3 seconds, preferably in 1.6 seconds.

Accordingly, the present embodiment can attain the function and effects that are similar to those of the previous embodiments.

### Embodiment 4

The present embodiment 4 includes both seat mounts 44 of the second slide portions 36b as the support portion and a hydraulic driving device 67 as the movement portion. Although hereinafter the present embodiment that is applied to the assistant seat will be described, this embodiment can be applied to the driver's seat as well.

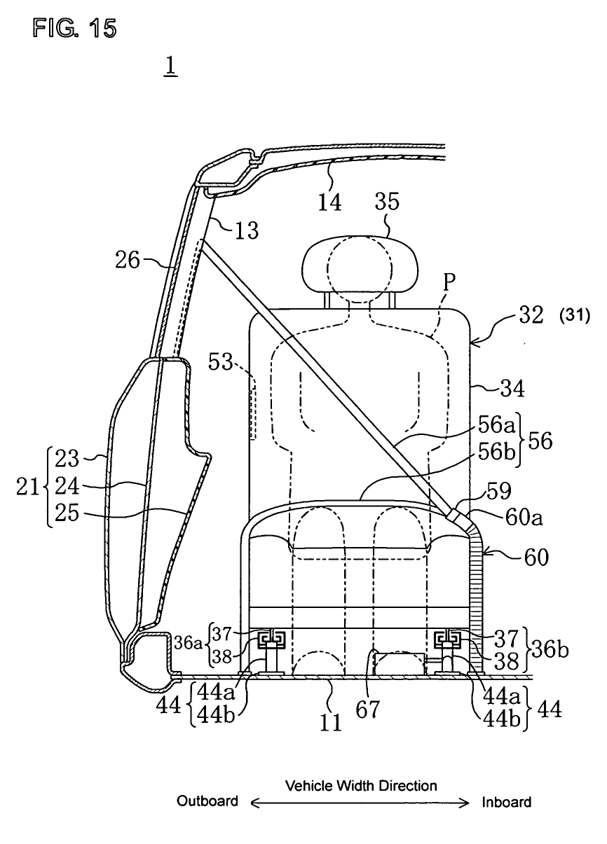

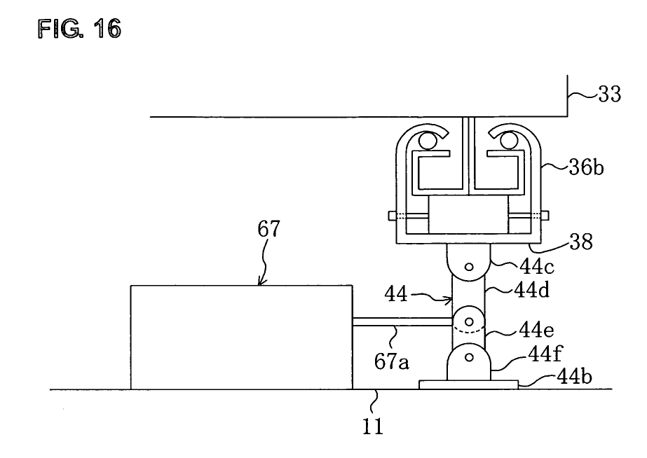

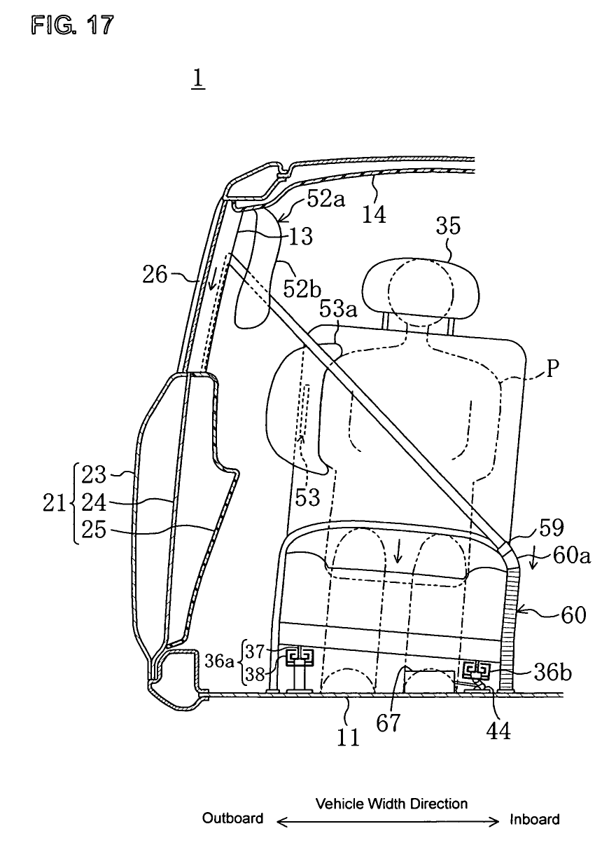

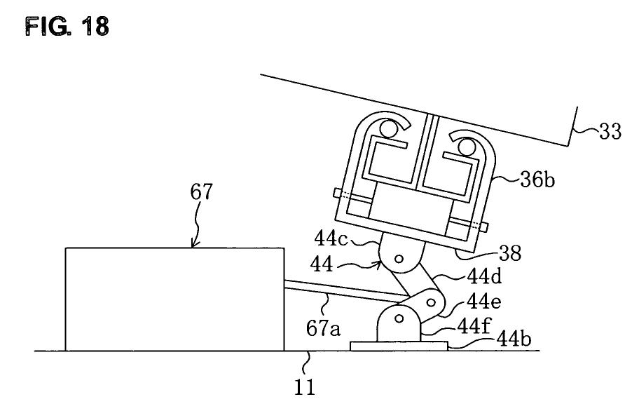

As illustrated in FIGS. 15-18, the shaft members 44a of the both seat mounts 44 of the second slide portion 36b can bend, and each shaft member 44a includes a first shaft portion 44c, second shaft portion 44d, third shaft portion 44e, and forth shaft portion 44f. The first shaft portion 44c is fixed to the lower face of the lower guide portion 38 of the second slide portion 36b. The second shaft portion 44d is attached rotatably to the first shaft member 44c around an axis extending longitudinally at its upper end, and to the upper end of the third shaft portion 44e around an axis extending longitudinally at its lower end. The third shaft portion 44e is attached rotatably to the forth shaft member 44f around an axis extending longitudinally at its lower end. The forth shaft portion 44f is attached to the upper face of the bottom plates 44b. Each seat mount 44 of the second slide portion 36b has its normal standing state with the shaft member 44a extending in the vertical direction (see FIGS. 15 and 16). When the vehicle side crash or rollover is predicted by the controller 90, the seat amount 44 has its bent state where the shaft member 44a is bent inward at a connecting portion between the second and third shaft portions 44d, 44e (see FIGS. 17 and 18). Thus, since the seat mount 44 of the second slide portion 36b changes from its standing state to its bent state receiving weights of the occupant P and the seat when the vehicle side crash or rollover is predicted by the controller 90, the seat is inclined such that the inboard portion of the rear part of the seat cushion 33 is lowered. As a result, the upper portion body of the occupant P is inclined toward the vehicle center, the upper portion body, or the head of the occupant P is moved toward the vehicle center.

The driving device 67 includes a rod 67a and is located outboard the seat mount 44 on the seat floor panel 11. The rod 67a is coupled to the connecting portion between the second and third shaft portions 44e, 44e. The rod 67a extends and pushes this connecting portion inward according to the prediction of the vehicle side crash or rollover by the controller 90. Thereby, the seat mount 44 changes from its standing state from its bent state in the short time of 3 seconds, preferably in 1.6 seconds.

The other end of the seat belt 56 is fixed to the outboard end of the upper face of the floor panel 11. The buckle portion 60 is fixed to the center of the upper face of the floor panel 11. Namely, the inboard end (the end located at the vehicle center side) of the seatbelt device 55.

As described above, according to the present embodiment, since the support portion is comprised of the seat mount 44, the seat cushion needs not to be modified substantially, so the comfortable sitting of the seat can be maintained properly.

Herein, although the buckle portion 60 is fixed to the center of the upper face of floor panel 11 in the present embodiment, it may be attached to the inboard end portion of the seat cushion 33.

Also, although the other end of the seat belt 56 is fixed to the outboard end of the upper face of floor panel 11 in the present embodiment, it may be attached to the outboard end the seat.

Also, although the seat mount 44 of the second slide portion 36b changes from its standing state to its bent state when the vehicle side crash or rollover is predicted by the controller 90 in the present embodiment, the seat mount 44 of the second slide portion 36b may be removed by any means.

### Modifications of Embodiments

Although the controller 90 of the above-described embodiments predict and detect the side crash and rollover of the vehicle 1, it may be the device to predict or detect the side crash or rollover of the vehicle 1.

Also, although the inboard portion of the buttocks of the occupant P is lowered when the vehicle side crash or rollover is predicted in the above-described embodiments, it may be lowered when the vehicle side crash or rollover is detected by the controller 90. From the viewpoint of secure protection of the occupant P, however, it may be preferable that it is lowered when the vehicle side crash or rollover is predicted by the controller 90.

Also, although the retractor of the seatbelt device 55 is attached at the lower portion of the pillar 13 in the above-described embodiments, it may be disposed in the seat back 34.

Also, the buckle portion 60 may be attached to the center portion of the upper face of the floor panel 11 instead of to the inboard end of the seat cushion 33 of the seat like the above-described embodiments. In this case, the lap pre-tensioner 60b and the shoulder pre-tensioner may be operated after the seat position is changed. Herein, it is preferable that the lap pre-tensioner 60b and the shoulder pre-tensioner is operated even if the seat operation is underway when the vehicle side crash or rollover is detected by the controller 90.

Also, although the shoulder pre-tensioner is operated after the operation of the lap pre-tensioner 60b in the above-described embodiments, only the lap pre-tensioner 60b may be operated from the viewpoint of promoting the occupant's head movement toward the vehicle center by the seat cushion airbag unit 51.

Also, the outboard end portion of the lap belt portion 56b may be pulled down instead of the inboard end portion of that when the vehicle side crash or rollover is predicted by the controller 90. Herein, it may be preferable that the inboard end portion of the lap belt portion 56b is pulled down from the viewpoint of moving surely the occupant's head toward the vehicle center.

Also, the above-described slide tensioner 43 may be provided at both the first and second slide portions 36a, 36b, instead of only at the first slide portion 36a.

Also, the occupant's head is moved to the specified near the pillar 13 by making the parallel bar 41 contact the rear end of the slot 38e of the lower guide member 38 with the operation of the slide tensioner 43 when the vehicle side crash or rollover is predicted by the controller 90 in the above-described embodiment. Herein, the occupant's head may be moved to the specified near the pillar 13 with the operation of the slide tensioner 43 based on the detection data from the seat position sensor 78 and the rearward-inclined angle sensor 79.

Also, although both inflators of the side airbag unit 53 and the pressing airbag unit 54 are operated concurrently (namely, the both airbags 53a, 54a are inflated at the same time), the inflator of the pressing airbag unit 54 may be inflated right after the operation of the inflator of the side airbag unit 53 (namely, just after the side airbag 53a is operated, for example, in a few milliseconds after the operation of the inflator of the side airbag unit 53).

Also, although the pressing airbag 54a is used as the pressing device in the above-described embodiment, any other means to push the outboard portion of the occupant inward instead of the airbag may be used.

Also, the pressing airbag 54a may be provided at the pillar 13 or the side wall portion instead of at the side door of the above-described embodiment. Herein, it may be preferable that the pressing airbag 54a is located to be opposed to the outboard portion of the occupant's chest is opposed to said pressing device when the vehicle side crash or rollover is detected by the controller 90, so that the occupant P can be pushed surely inward.

Also, although the above-described pressing airbag 54a pushes the occupant P via the side airbag 53a, the occupant P may be pushed by the pressing airbag 54a directly without the side airbag 53a. In this case, it is preferable that the pressing airbag 54a has a relatively long length in the longitudinal direction, for example, the longitudinal length of the pressing airbag 54a is configured so as to be longer than that of the vertical length of the airbag 54a. Thereby, the occupant P can be directly pushed surely by the pressing airbag 54a.

Also, the side airbag 53a may be operated when the controller 90 predicts the vehicle side crash or rollover, instead of when the controller 90 detects those like the above-described embodiment. In this case, it is preferable that the pressing airbag 54a is operated when the vehicle side crash or rollover is predicted (namely, at the same time, or right after the operation of the side airbag 53a) so that the occupant P can be pushed surely by the pressing airbag 54a via the side airbag 53a.

Also, although the seat position is changed when the controller 90 predicts the vehicle side crash or rollover in the above-described embodiment, the seat may not hanged in position. In this case, it is preferable that the pressing airbag 54a has the relatively long length in the longitudinal direction, for example, the longitudinal length of the pressing airbag 54a is configured so as to be longer than that of the vertical length of the airbag 54a so that the occupant P can be pushed surely by the pressing airbag 54a.

Also, the seat position may be changed when the controller 90 detects the vehicle side crash or rollover instead of when the controller 90 predicts the vehicle side crash or rollover. In any case, it is preferable that the seat positron is changed before the operation of the pressing airbag 54a such that the outboard portion of the occupant's chest is located to be opposed to the pressing airbag 54a. Thereby, the occupant P can be pushed surely inward.

Also, any slide mechanisms other than the mechanism disclosed in the above-described embodiment can be applied as long as the seat is moved longitudinally.

Also, any drive devices other than the slide tensioner 43 disclosed in the above-described embodiment can be applied as long as the slide mechanism 36 is operated so as to locate the occupant P being opposed to the pressing airbag 54a when the vehicle side crash or rollover is predicted by the controller 90.

The present invention should not be limited to the above-described embodiment, and any modifications and improvements can be applied within the scope of a sprit of the present invention.

What is claimed is:

1. An occupant protection device for a vehicle, comprising:
a determining device operative to electrically predict or detect a vehicle side crash or rollover; and
a moving device operative to move a head of an occupant seated in a seat toward a center of the vehicle without a rise in a position of the occupant's head when the vehicle side crash or rollover is predicted or detected by said determining device.

2. The occupant protection device for a vehicle of claim 1, wherein said moving device comprises a support portion operative to support an inboard portion of buttocks of the occupant, and a movement portion operative to deform, change or remove said support portion, thereby lowering the inboard portion of the occupants' buttocks when the vehicle side crash or rollover is predicted or detected by said determining device.

3. The occupant protection device for a vehicle of claim 2, wherein said support portion is accommodated in an inboard portion of a seat cushion of the seat, and said movement portion is configured so as to deform or change said support portion.

4. The occupant protection device for a vehicle of claim 2, wherein said support portion is a seat mount that is located below an inboard portion of the seat, and said movement portion is configured so as to bend or remove said seat mount.

5. The occupant protection device for a vehicle of claim 3, further comprising a seatbelt device whose inboard end portion is fixed to an inboard end portion of the seat, wherein said seatbelt device comprises a seatbelt to restrain the occupant in the seat and a tension mechanism to apply a tension to said seatbelt according to a movement of said movement portion, thereby restraining a lower portion of an occupant's body in the seat cushion.

6. The occupant protection device for a vehicle of claim 4, further comprising a seatbelt device whose inboard end portion is fixed to a central portion of a vehicle body, wherein said seatbelt device comprises a seatbelt to restrain the occupant in the seat and a tension mechanism to apply a tension to said seatbelt according to a movement of said movement portion, thereby restraining a lower portion of an occupant's body in the seat cushion.

7. The occupant protection device for a vehicle of claim 5 or 6, wherein said tension mechanism is configured so as to apply the tension to said seatbelt according to the movement of said movement portion, thereby restraining the lower portion of the occupant's body in the seat cushion and an upper portion of the occupant's body in a seat back, a restraint timing of the lower portion of the occupant's body in the seat cushion being earlier than that of upper portion of the occupant's body in the seat back, or a restraint force of the lower portion of the occupant's body in the seat cushion being greater than that of the upper portion of the occupant's body in the seat back along with the same restraint timing.

8. The occupant protection device for a vehicle of claim 1, further comprising a pressing device that is provided at a side door, a pillar or a side wall portion of the vehicle and operative to push the occupant inward during or after an operation of said moving device.

9. The occupant protection device for a vehicle of claim 8, wherein said pressing device is configured so as to push an outboard portion of an occupant's chest inward.

10. The occupant protection device for a vehicle of claim 8, wherein said pressing device is configured so as to operate after the operation of said moving device.

11. The occupant protection device for a vehicle of claim 10, wherein said pressing device comprises a pressing airbag operative to be inflated inward after the vehicle side crash or rollover is predicted and when the vehicle side crash or rollover is detected by said determining device.

12. The occupant protection device for a vehicle of claim 8, further comprising a side airbag that is accommodated within the seat and operative to be inflated so as to cover an outboard portion of an upper portion of an occupant's body when the vehicle side crash or rollover is predicted or detected by said determining device, and said pressing device comprises a pressing airbag operative to be inflated inward and push said side airbag inward that is under inflation or inflated.

13. The occupant protection device for a vehicle of claim 8, further comprising a seat slide mechanism to enable the seat to slide in a vehicle longitudinal direction, and a drive device to operate said seat slide mechanism, wherein the seat is positioned by said seat slide mechanism when the vehicle side crash or rollover is predicted or detected by said determining device in such a manner that an outboard portion of the occupant is opposed to said pressing device.

14. The occupant protection device for a vehicle of claim 9, wherein said moving device is configured so as to lower an inboard portion of buttocks of the occupant when the vehicle side crash or rollover is predicted or detected by said determining device.

15. The occupant protection device for a vehicle of claim 1, wherein the vehicle includes a plurality of seats including a driver's seat, and said moving device is configured so as to move the occupant's heads seated in said plural seats toward the center of the vehicle by changing positions or forms of the plural seats in such a manner that a changing degree of the position or form of the driver's seat is smaller than that of a seat other than the driver's seat.

16. The occupant protection device for a vehicle of claim 1, wherein the vehicle includes a plurality of seats including a driver's seat, and said moving device is configured so as to move the occupant's head seated in at least one of said plural seats that is other than the driver's seat toward the center of the vehicle by changing position or form of said at least one of the plural seats.

17. The occupant protection device for a vehicle of claim 15 or 16, wherein said determining device is configured so as to predict or detect the vehicle rollover, and said moving device is configured so as to move an upper portion of body of said occupant toward the center of the vehicle when the vehicle rollover is predicted or detected by said determining device.

18. The occupant protection device for a vehicle of claim 17, wherein said moving device is configured so as to lower an inboard portion of buttocks of said occupant or raise an outboard portion of buttocks of said occupant when the vehicle rollover is predicted or detected by said determining device and the vehicle travels with wheels located at either one side of vehicle contacting a ground surface.

19. The occupant protection device for a vehicle of claim 15, wherein said determining device is configured so as to predict or detect the vehicle rollover, said moving device is configured so as to move an upper portion of body of said occupant toward the center of the vehicle when the vehicle rollover is predicted or detected by said determining device, and said changing degree of the position or form of the driver's seat is configured so as to be smaller than that of the seat other than the driver's seat when the vehicle rollover is predicted and to be substantially the same as that of the seat other than the driver's seat after the vehicle rollover is predicted and when the vehicle rollover is detected by said determining device.
